(19) United States
(12) Patent Application Publication
(10) Pub. No.: US 2010/0091479 A1
(43) Pub. Date: Apr. 15, 2010

(54) LIGHTING SYSTEM FOR PRODUCING A PLURALITY OF ILLUMINATION PATTERNS

(76) Inventor: Joseph Martin, Harrisburg, PA (US)

Correspondence Address: L.C. BEGIN & ASSOCIATES, PLLC, 510 HIGHLAND AVENUE, PMB 403, MILFORD, MI, 48381, US

(21) Appl. No.: 12/555,045

(22) Filed: Sep. 8, 2009

Related U.S. Application Data
(60) Provisional application No. 61/104,744, filed on Oct. 12, 2008.

(51) Int. Cl. F21V 21/30

(52) U.S. Cl. 362/35

(57) ABSTRACT

One embodiment of a lighting system may have a rotating unit that may include a body movable in a plurality of rotational patterns and a motor that may be configured to move the body in the plurality of rotational patterns. The lighting system may also have a light source that may be carried by the body. The light source may have a light emitting section that may be configured to emit light. In addition, the lighting system may further include a light scattering device that may be carried by the light emitting section of the light source. The light scattering device may be configured to scatter the light emitted from the light source for producing a plurality of illumination patterns that may be based on the plurality of rotational patterns of the body.

### CROSS REFERENCE TO RELATED APPLICATION

This application claims the benefit of U.S. Provisional Application No. 61/104,744, filed on Oct. 12, 2008, which is incorporated by reference.

### FIELD OF THE INVENTION

The present disclosure relates generally to a lighting system, and, more particularly, to a lighting system capable of producing multiple illuminations patterns and which requires low power consumption.

### BACKGROUND OF THE DISCLOSURE

Many lighting systems are used to improve visibility by, for example, providing static or steady light in one general area. Lighting systems in homes may include incandescent bulbs or other light sources carried by fixtures that are connected to the electrical wiring of the home. These lighting systems typically illuminate one area of the home with a steady exposure of light.

Accordingly, existing lighting systems may not provide stimulating or aesthetically pleasing lighting to individuals, including those who are bedridden or rarely leave a single room. Further, the lighting systems that may have incandescent bulbs which may consume a somewhat high amount of electricity.

### SUMMARY OF THE INVENTION

One embodiment of a lighting system may have a rotating unit that may include a body movable in a plurality of rotational patterns and a motor that may be configured to move the body in the plurality of rotational patterns. The lighting system may also have a light source that may be carried by the body. The light source may have a light emitting section that may be configured to emit light. In addition, the lighting system may further include a light scattering device that may be carried by the light emitting section of the light source. The light scattering device may be configured to scatter the light emitted from the light source for producing a plurality of illumination patterns that may be based on the plurality of rotational patterns of the body.

### BRIEF DESCRIPTION OF THE DRAWINGS

These and other features and advantages of the present invention will be apparent from the following detailed description of preferred embodiments and best mode, appended claims, and accompanying drawings in which:

FIG. 1A is a partially sectional view of one embodiment of a lighting system;

FIG. 1B is a perspective view of the lighting system of FIG. 1A; and

FIG. 2 is a perspective view of the lighting system of FIG. 1A, showing a representation of an illumination pattern produced by the lighting system.

Like reference numerals refer to like parts throughout the description of several views of the drawings.

### DETAILED DESCRIPTION OF THE INVENTION

The exemplary embodiments described herein in detail for illustrative purposes are subject to many variations in composition, structure, and design. It should be emphasized, however, that the present disclosure is not limited to a lighting system, as shown and described. It is understood that various omissions and substitutions of equivalents are contemplated as circumstances may suggest or render expedient, but these are intended to cover the application or embodiment without departing from the spirit or scope of the claims of the present disclosure. Also, it is to be understood that the phraseology and terminology used herein is for the purpose of description and should not be regarded as limiting.

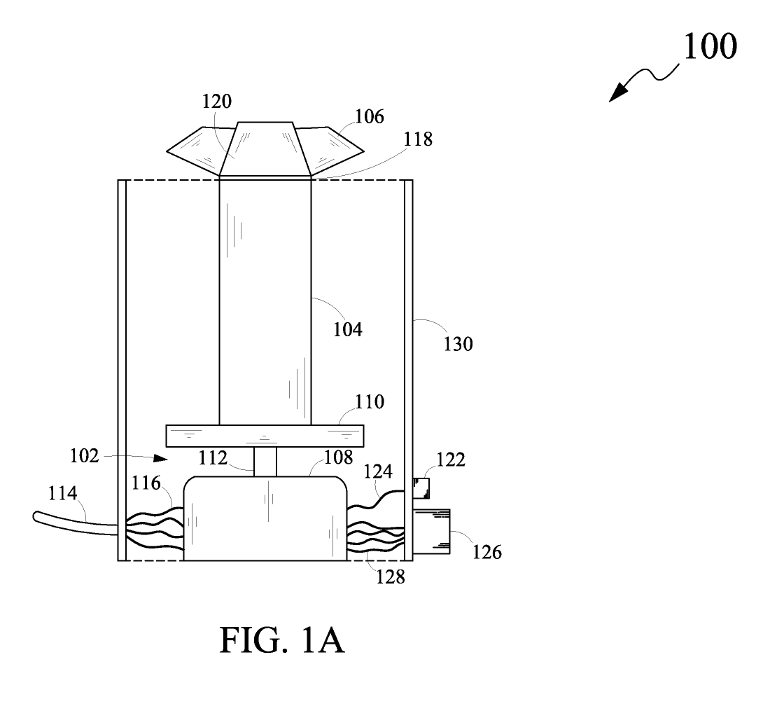

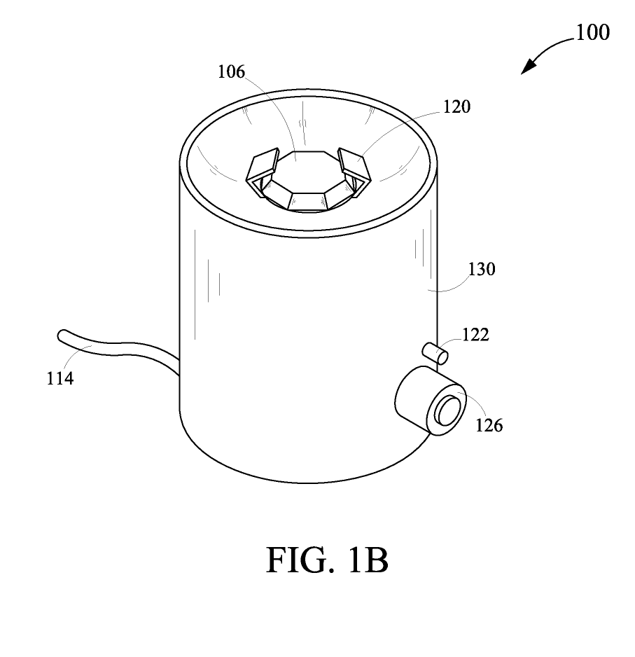

Referring to FIGS. 1A and 1B, one embodiment of a lighting system 100 may include a rotating unit 102 that may have a body 110 that may be movable in plurality of rotational patterns and a motor 108 that may be configured to move the body 110 in those rotational patterns. The body 110 may be carried by the motor 108 by at least one coupling member such as a coupling member 112. For example, the coupling member 112 may include a spindle or suitable coupling techniques know in the art. The motor 108 may be operated through an AC power cord 114 (hereinafter referred to as “the power cord 114”) that may be coupled to the motor 108 through a first wiring system 116. Alternatively, the motor 108 may be operated through a battery.

The lighting system 100 may also include a light source 104 that may be carried by the body 110. For example, the light source 104 may be mounted on an end of the body 110 and extend vertically upward therefrom. The light source 104 may have a light emitting section 118 (hereinafter referred to as the section 118) configured to emit light. The section 118 in one form may be a top portion of the light source 104. The light source 104 may include, but is not limited to, a Light Emitting Diode (hereinafter referred to as “LED”). The light source 104 may also include a combination of LEDs.

The lighting system 100 may further have a light scattering device 106 that may be carried by the section 118 of the light source 104. In one embodiment, the light scattering device 106 may be a faceted crystal. However, the light scattering device 106 may instead be a prism, a wave guide or other light scattering mechanisms. The light scattering device 106 may be removably carried by the section 118 by a fastener 120. Examples of the fastener 120 may include, but is not restricted to, a spring clamp, a clip and other suitable fasteners. In one embodiment, the fastener 120 may also aid the light scattering device 106 to rotate in the plurality of directions along with the rotation of the light source 104. The light scattering device 106 may be adjusted at variety of positions on the light source 104 surrounding the section 118 through the fastener 120. The light scattering device 106 may produce illumination patterns, which may form various images when the light is scattered projected onto a surface.

In operation, the motor 108 may be used to move the body 110 and the light source 104 carried by the body 110 in the plurality of rotational patterns. The light emitting section 118 of the light source 104 may project light to the light scattering device 106, which may scatter the projected light to form a plurality of illumination patterns. For example, the light scattering device 106 may produce an illumination pattern on a ceiling. Of course, the light scattering device 106 may instead produce the illumination pattern on one or more walls, other surfaces within a room or any combination thereof.

The plurality of illumination patterns may be based on the rotational patterns of the body 110, more specifically based on the plurality of rotational patterns of the light source 104. The rotational pattern may be based on a plurality of directions in which the light source 104 may be rotated. For example, the body 110 and the light source 104 may be rotatable in a clockwise direction and a counterclockwise direction. Such directions may be controlled by a switch 122 that may be coupled to the motor 108 through a second wiring system 124. Accordingly, a user may operate the switch 122 to adjust the direction in which the body 110 is rotated. By way of another example, the rotational pattern may be based on a plurality of speeds at which the body 110 and the light source 104 are rotated. The lighting system may include a speed control knob 126 connected to the motor 108 through a third wiring system 128. Accordingly, a user may operate the knob 126 to adjust the speed at which the body 110 and light source 104 are rotated, at different points of time. In one embodiment, the speed may be regulated within a range of 0 to 30 revolutions per minute. Of course, the speed control knob 126 may be used to operate the motor to rotate the body 110 and light source 104 at speeds greater than 30 revolutions per minute. In addition, the rotational patterns of the body 110 and the light source 104 may be based on changes in direction, speed, other parameters or any combination thereof.

Further, the lighting system 100 may include a housing 130 for at least partially enclosing the motor 108, the body 110, the coupling member 112, light source 104, the first wiring system 116, the second wiring system 124, and the third wiring system 128. Hereinafter, the first wiring system 116, the second wiring system 124, and the third wiring system 128 may collectively be referred to as the wiring system. The housing 130 may provide covering to various components of the lighting system 100, such as the motor 108, the body 110, the coupling member 112, the light source 104 and the wiring system. The light scattering device 106, the fastener 120, the switch 122, the speed control knob 126, and the power cord 114 are visible in FIG. 1B, which in this form are outside of the housing 130.

The housing 130 in this form may be coaxial with the light source 104 such that the light scattering device 106 and the fastener 120 may be disposed above the section 118 of the light source 104. Further, the fastener 120 and the light scattering device 106 may also rotate (along with the rotation of the light source 104) above the section 118 of the light source 104. The housing 130 may be in coaxial relationship with a top portion of the fastener 120 to provide partial covering to both the light scattering device 106 and the fastener 120. Of course, the light scattering device 106 may be located in other positions with respect to the light source 104. The housing 130 may include an opening from a top portion thereof and thereby allow the light scattering device 106 to scatter the light of the light source 104 outside the housing 130 through the opening. The housing 130 may be made of materials such as, wood, plastic, metal or glass. Further, the housing 130 may be of various shapes, for example, rectangular, cylindrical or spherical, and of various sizes.

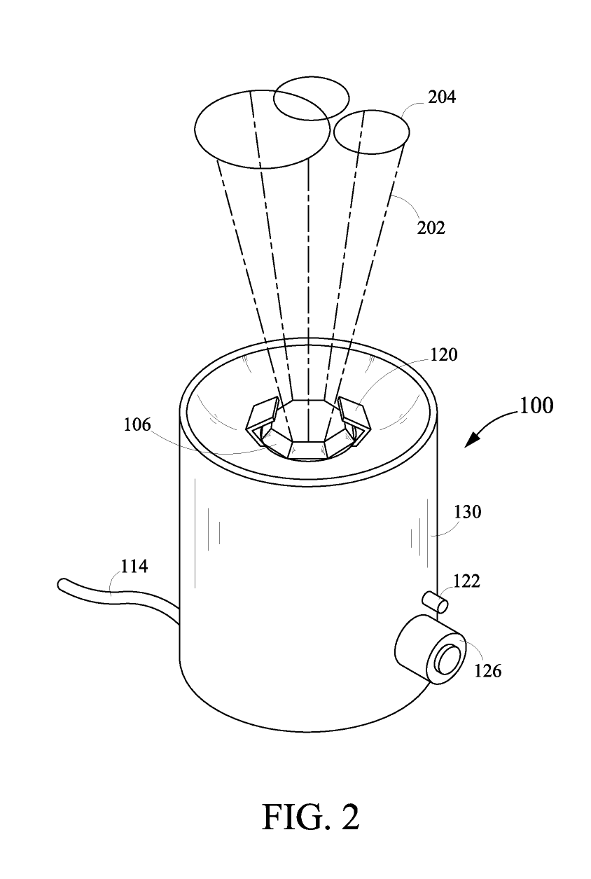

Referring now to FIG. 2, there is shown a perspective view of the lighting system 100 of FIG. 1A and a representation of an illumination pattern produced by the system 100. The light scattering device 106 may transmit the light through various facets of the faceted crystal to produce a scattering 202 of light above the device 106. The scattering 202 may be projected onto a surface, such as a ceiling, to produce the illumination pattern 204. The light scattering device 106 may produce a plurality of illumination patterns based on at least one of a direction and speed of rotation of the light source 104. Further, the plurality of illumination patterns may also be based on the position of the light scattering device 106 relative to the light source 104 and the manner in which light is scattered by the light scattering device 106. Accordingly, due to changes in the direction of rotation and speed of rotation of the light source 104, and changes in the direction of the light emitted from the light source 104, the plurality of illumination patterns may be produced by the lighting system 100.

The lighting system 100 as described above is not restricted to the type of components and functioning thereof as mentioned above. The exact dimensions, shapes, materials used for construction and operation of the lighting system 100 may vary from as shown in FIGS. 1A, 1B and 2.

As described above, the present disclosure provides a lighting system, such as the lighting system 100 for providing interactive illumination patterns. The lighting system provides an individual with options of producing various interesting illumination patterns. Due to this, the lighting system is capable of minimizing boredom while providing the light. Further, due to this, the lighting system may be utilized as therapy in nursing homes, hospitals and in other areas of medical field. The lighting system as described herein, multiplies the light emitted from a light source of the lighting system by scattering the light from light scattering device and thus may provide more illumination with minimal electricity requirements. Accordingly, the lighting system may decrease energy bills as compared to traditional lighting.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention. For example, without limitations, the lighting system could be used in connection with a vehicle during any time of the day rather than being disposed in a fixed location, such as one room of a building.

What is claimed is:

1. A lighting system, comprising:
a rotating unit having a body movable in a plurality of rotational patterns and a motor configured to move the body in the plurality of rotational patterns;
a light source carried by the body and having a light emitting section configured to emit light; and
a light scattering device carried by the light emitting section of the light source, the light scattering device configured to scatter the light emitted from the light source for producing a plurality of illumination patterns based on the plurality of rotational patterns of the body.

2. The lighting system of claim 1 further comprising a housing for at least partially enclosing the rotating unit, the light source and the light scattering device.

3. The lighting system of claim 1, wherein the plurality of rotational patterns comprises rotating the body at a plurality of rotational speeds.

4. The lighting system of claim 3 further comprising a speed control knob, the speed control knob operatively coupled to the motor, wherein the speed control knob is configured for rotating the body at the plurality of rotational speeds.

5. The lighting system of claim 1, wherein the plurality of rotational patterns comprises rotating the body in a plurality of directions.

6. The lighting system of claim 5, further comprising a switch operatively coupled to the motor, wherein the switch is capable of rotating the body in the plurality of directions.

7. The lighting system of claim 1 further comprising a fastener carried by one of the light source and the light scattering device, wherein the fastener is configured to removably secure the light scattering device on the light emitting section of the light source.

8. The lighting system of claim 1, wherein the light source comprises at least one Light Emitting Diode (LED).

9. The lighting system of claim 1, wherein the light scattering device comprises a faceted crystal.
